(19) United States
(12) Patent Application Publication
(10) Pub. No.: US 2006/0044120 A1
(43) Pub. Date: Mar. 2, 2006

(54) Car audio system and method combining with MP3 player

(75) Inventor: Wen-Hsiang Yueh, Taipei County (TW)

Correspondence Address: BACON & THOMAS, PLLC, 625 SLATERS LANE, FOURTH FLOOR, ALEXANDRIA, VA, 22314, US

(73) Assignee: Partner Tech. Corporation, Taipei County (TW)

(21) Appl. No.: 11/187,799

(22) Filed: Jul. 25, 2005

(30) Foreign Application Priority Data
Aug. 30, 2004 (TW) 93126054

(51) Int. Cl. H04B 1/00

(52) U.S. Cl. 340/426.1; 381/86; 340/825.72

(57) ABSTRACT

The car audio system combining with a MP3 player of the present invention comprises an audio system, a MP3 player, and a connecting interface. The audio system comprises an audio host, a microphone, and a speaker, wherein the audio host has a speaker phone mode. The MP3 player comprises a MP3 module and a wireless earphone module, wherein the MP3 module will establish a bidirectional communication with a mobile phone via the wireless earphone module. The connecting interface will connect the electrical connection between the MP3 module and the audio host. When a call comes into the mobile phone, the MP3 module will enable the audio system to enter the speaker phone mode to make the audio system establish a bidirectional audio communication with the mobile phone.

### FIELD OF THE INVENTION

The present invention relates to a car audio system, more particularly, to a car audio system combining with a MP3 player which can enable the audio system to enter the speaker phone mode to make the audio system establish a bidirectional audio communication with a mobile phone.

### BACKGROUND OF THE INVENTION

For the purpose of traffic safety, the new version of traffic safety punishment regulations published by the Ministry of Transportation and Communications have set severe penal regulations on the communication using non-speaker phone handset during driving. For increasing the safety of using mobile phone in driving and following the stipulation of forbidding using non-speaker phone handset, the car audio manufacturing industry has thus developed a car audio having embedded speaker phone so that the user can use the car audio as the speaker phone in driving. This can increase the driving safety, and in addition, the inconvenience of general simple speaker phone devices which have to be hung on the ear for a long time is removed.

A conventional speaker phone mainly comprises: a mobile phone receiving box, a circuit body, a power input contact, a microphone, a speaker, and an antenna for use outside the car. The quantity of assemblies is many, and it is not only difficult to install, but also the influence on the arrangement in the car is great. If the related hardware such as electric wire is provided everywhere in the car, it is disorderly and there is a concern of safety. Furthermore, when the circuit body of the mobile phone is in use, it must use the power of the car. The power generally comes from the cigar-lighter or another tapped power source. It needs to change the original circuit design of the car in order to install the tapped power source, such that it needs complicated techniques and has a concern of safety. If the power of the cigar-lighter is directly used, other equipments, such as the cigar-lighter, can not be used.

Cars of European specification combine the audio system with a mobile phone. The circuit module of a mobile phone is provided inside the audio host such that the circuit module will be compatible with the circuit module of the audio host. These two circuit modules will form an integrated circuit module together by sharing mutual circuit resources or input and output devices. The integrated circuit module can connect the connection terminal hole of the mobile phone provided on the car audio panel, and the panel thereof also has the same arrangement as that of the mobile phone. Accordingly, the user can directly insert the SIM card of the mobile phone into the terminal hole, it is expedient to use the car audio as a mobile phone for communication.

As to the audio system of cars of Asian specification, the speaker phone is designed to use a transmission line to connect the original car audio system inside the car. Users can use the speaker of the audio system as an output means, however, they still have to use the mobile phone body to make a phone call. The high power, high fidelity of the speaker of the car audio can increase the quality of conversation, thereby increasing the safety of driving.

Nevertheless, although the speaker phone combined with the car audio of either specification generally has many convenient advantages, the disadvantage associated with ‘right of privacy’ still exists due to use of the speaker of the car audio as an output means. If other people are in the car, sometimes it is not convenient to output the conversation contents of a call of the mobile phone via the speaker of the car audio to make everybody hear the conversation contents. At the same time, the driver should not answer the call by himself so that violating the traffic safety rules. Therefore, as to use of the speaker of the car audio as an output means, further improvements are needed to make.

### SUMMARY OF THE INVENTION

The object of the present invention is to combine with the technology disclosed in the granted patent no. 92121117 and entitled ‘MP3 Player Able to Temporarily Stop Playing/Receiving a Call of a Handset’ and apply to a car audio system, thereby making the wireless earphone or the function of receiving a call of a handset of the MP3 player become the interface to establish a bidirectional audio communication between the car audio system and the mobile phone.

The object of the present invention is to provide a car audio system and method which can make the car audio system have the function of wireless speaker phone by electrically connecting a MP3 player which can wirelessly receive the incoming call of a handset to the audio host.

For the purpose of protecting the right of privacy of the driver, the object of the present invention is to provide a car audio system and method which uses a wireless earphone device as the wireless communication medium between the audio host and a mobile phone, such that the car audio system can have the function of wireless speaker phone, the wireless earphone device can depart from the car audio system anytime, and the wireless communication between the wireless earphone device and the mobile phone is kept.

In one of the preferred embodiments according to the present invention, a car audio system comprises an audio system, a MP3 player, and a connecting interface. The audio system comprises an audio host, a microphone, and a speaker, wherein the audio host has a speaker phone mode. The MP3 player comprises a MP3 module and a wireless earphone module, wherein the MP3 module will establish a bidirectional communication with a mobile phone via the wireless earphone module. The connecting interface will connect the electrical connection between the MP3 module and the audio host, so that the MP3 module will enable the audio host to enter the speaker phone mode while the MP3 module establishes a bidirectional communication with the mobile phone.

In one of the preferred embodiments according to the present invention, a car audio system comprises an audio system, a MP3 player, and a wireless earphone device. The audio system comprises an audio host, a microphone, and a speaker. The audio host has a speaker phone mode. The wireless earphone device may establish a wireless connection with a mobile phone. Wherein a first connecting interface may connect the electrical connection between the MP3 player and the wireless earphone device, a second connecting interface may connect the electrical connection between the MP3 module and the audio host, so that the MP3 module will enable the audio host to enter the speaker phone mode while the MP3 module establishes a bidirectional communication with the mobile phone via the wireless earphone device.

According to these above embodiments, the present invention provides a method for allowing an audio host to combine with a MP3 player in order to establish a wireless communication, the audio host has the function of speaker phone, wherein the method comprises the following steps:
providing a connecting interface so that there is an electrical connection between the MP3 module and the audio host;
the MP3 player may establish a bidirectional communication with a mobile phone via a wireless earphone device; and
the MP3 player may generate an enable signal to enable the audio host to enter the speaker phone mode in response to the indication of an incoming call of the mobile phone.

In the car audio system implemented according to the present invention, the audio host can electrically connect a MP3 player, and the MP3 player has the function of receiving a call of a handset. Thus, when the audio host performs the broadcast operation, the MP3 player may generate an enable signal to enable the audio host to enter the speaker phone mode in response to the indication of an incoming call of the mobile phone, so that the driver can make a choice to use the car audio system or a separate wireless earphone device to receive the incoming call of the handset.

### BRIEF DESCRIPTION OF ILLUSTRATIONS

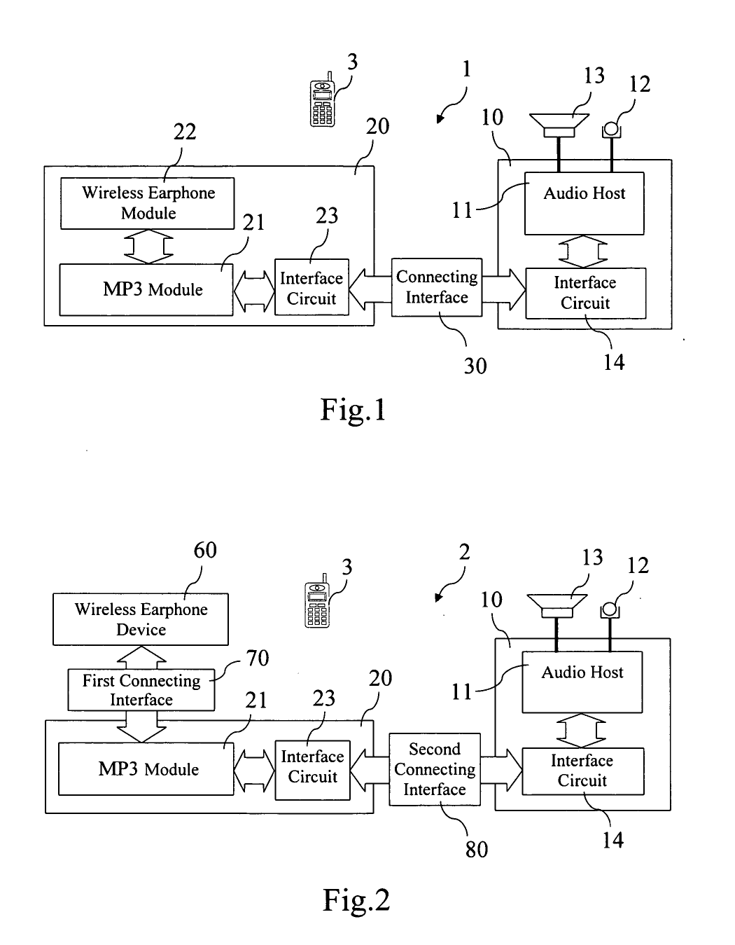

FIG. 1 is a block diagram of a car audio system according to the first embodiment of the present invention.

FIG. 2 is a block diagram of a car audio system according to the second embodiment of the present invention.

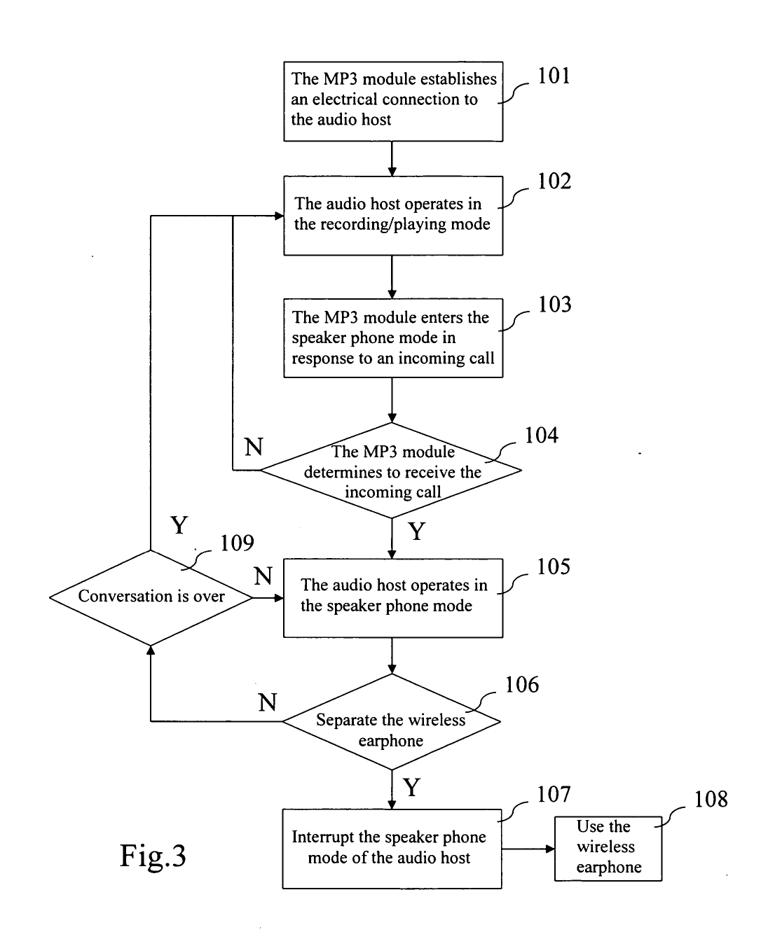

FIG. 3 is a method flowchart of the car audio system according to the present invention.

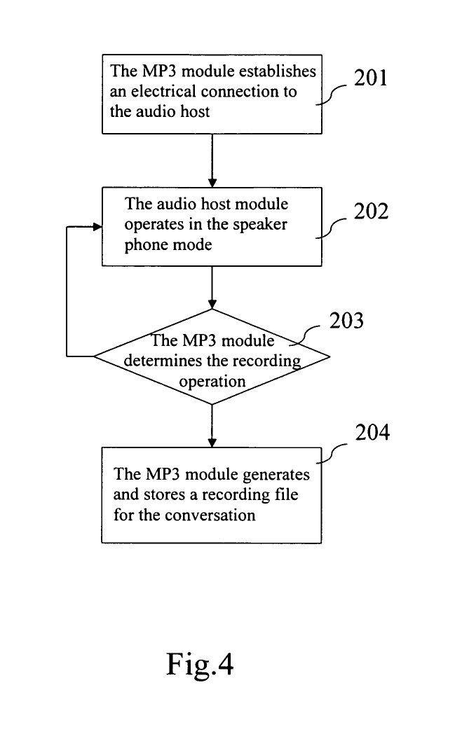

FIG. 4 is a recording flowchart of the car audio system according to the present invention.

### DETAILED DESCRIPTION OF THE INVENTION

While the present invention will be sufficiently described referring to drawings containing preferred embodiments of the present invention, however, it should be understood that those skilled in the art may modify the present invention described herein and obtain the same performance. Thus, it must be understood that the following description is a general disclosure to those skilled in the art and contents thereof is not intended to limit the present invention.

Referring FIG. 1, a block diagram of a car audio system according to the first embodiment of the present invention is illustrated. In this embodiment of the present invention, the car audio system 1 combining with a MP3 player of the present invention comprises an audio system 10, a MP3 player 20, and a connecting interface 30. The audio system 10 comprises an audio host 11, a microphone 12, and a speaker 13, wherein the audio host 11 has a speaker phone mode. The microphone 12 and speaker 13 will be connected to the audio host 11. Thus, in the speaker phone mode, the audio host 11 may broadcast the audio signal from a mobile phone via the speaker 13, and receive the sound signal or driver's voice via the microphone 12.

The MP3 player 20 comprises a MP3 module 21 and a wireless earphone module 22, wherein the MP3 module 21 comprising: a memory unit for storing MP3 files or recording files; a DSP processor for processing the MP3 files to generate corresponding audio signals or recording files to be stored in the memory unit; and a key input unit for transmitting the instruction requested by a user to the DSP processor. With the original wireless communication function, such as Bluetooth Wireless Communication, between the wireless earphone module 22 and a mobile phone 3, the MP3 module 21 can control the wireless earphone module 22 to establish a bidirectional communication with the mobile phone 3.

The connecting interface 30 implements the electrical connection between the audio system 10 and the MP3 player 20. In this embodiment of the present invention, the connecting interface 30 comprises electrical connecting points or electrical connectors provided on the panel of the audio system 10, and electrical connecting points or electrical connectors provided on the MP3 player 20. The audio system 10 comprises an interface circuit 14, the interface circuit 14 may receive the signal from the MP3 player 20 via the connecting interface 30 and transmit it to the audio host 11, and the interface circuit 14 may also simultaneously transmit the signal from the audio host 11 to the MP3 player 20 via the connecting interface 30.

In addition, the MP3 player 20 comprises an interface circuit 23, the interface circuit 23 may receive the signal from the audio system 10 via the connecting interface 30 and transmit it to the MP3 module 21, and the interface circuit 23 may also simultaneously transmit the signal from the MP3 module 21 to the audio system 10 via the connecting interface 30.

The interface circuit 23 of the MP3 player 20, the connecting interface 30, and the interface circuit 14 of the audio system 10 will form the data exchange path between the MP3 module 21 and the audio host 11 together, thereby the MP3 module 21 may generate an enable signal in response to the indication of an incoming call of the mobile phone 3 after the wireless communication between the wireless earphone module 22 and the mobile phone 3 is established. The enable signal may enable the audio host 11 to enter the speaker phone mode via the data exchange path. In the speaker phone mode of the audio host 11, the MP3 module 21 will transmit the audio signal from the mobile phone 3 to the audio host 11 via the data exchange path, and the speaker 13 will broadcast the audio signal; the audio host 11 will transmit the sound signal collected by the microphone 12 to the MP3 module 21 via the data exchange path, so that the MP3 module 21 may transmit a signal to the mobile phone 3 by using the wireless earphone module 22. Regarding use of keys of the MP3 player 20 to identify the indication of an incoming call of the mobile phone 3 to receive or cut off the incoming call, it is implemented by the control between the MP3 module 21 and the wireless earphone module 22, and the description thereof is not repeated.

Referring to FIG. 2, a block diagram of a car audio system according to the second embodiment of the present invention is illustrated. In this embodiment of the present invention, the car audio system 1 combining with a MP3 player of the present invention comprises an audio system 10, a MP3 player 20, and a wireless earphone device 60. The wireless earphone device 60 may establish a wireless communication, such as Bluetooth Wireless Communication, with the mobile phone 3. The audio system 10 comprises an audio host 11, a microphone 12, and a speaker 13, wherein the audio host 11 has a speaker phone mode. The microphone 12 and speaker 13 will be connected to the audio host 11. Thus, in the speaker phone mode, the audio host 11 may broadcast the audio signal from a mobile phone via the speaker 13, and receive the sound signal or driver's voice via the microphone 12.

The MP3 player 20 comprises a MP3 module 21, wherein the MP3 module 21 comprising: a memory unit for storing MP3 files or recording files; a DSP processor for processing the MP3 files to generate corresponding audio signals or recording files to be stored in the memory unit; and a key input unit for transmitting the instruction requested by a user to the DSP processor. The present invention provides a first connecting interface 70 between the MP3 player 20 and the wireless earphone device 60. The first connecting interface comprises electrical connecting points or electrical connectors provided on the panel of the MP3 player 20, and electrical connecting points or electrical connectors provided on the wireless earphone device 60. The wireless earphone device 60 may selectively link to the MP3 player 20 or depart from the MP3 player 20. When an electrical connection between the MP3 player 20 and the wireless earphone device 60 is established via the first connecting interface 70, with the wireless communication function between the wireless earphone device 60 and the mobile phone 3, the MP3 module 21 then can control the wireless earphone device 60 to establish a bidirectional communication with the mobile phone 3.

In addition, the present invention provides a second connecting interface 80 for implementing the electrical connection between the audio system 10 and the MP3 player 20. The second connecting interface comprises electrical connecting points or electrical connectors provided on the panel of the audio system 10, and electrical connecting points or electrical connectors provided on the MP3 player 20. Thus, in this embodiment of the present invention, the MP3 player 20 will provide different electrical connecting points or electrical connectors to be respectively connected to the wireless earphone device 60 and the audio system 10.

The audio system 10 comprises an interface circuit 14. The interface circuit 14 may receive the signal from the MP3 player 20 via the second connecting interface 80 and transmit it to the audio host 11, and the interface circuit 14 may also simultaneously transmit the signal from the audio host 11 to the MP3 player 20 via the second connecting interface 80. In addition, the MP3 player 20 comprises an interface circuit 23. The interface circuit 23 may receive the signal from the audio system 10 via the connecting interface 30 and transmit it to the MP3 module 21, and the interface circuit 23 may also simultaneously transmit the signal from the MP3 module 21 to the audio system 10 via the second connecting interface 80.

In the second embodiment of the present invention, the first connecting interface 70, the MP3 player 20, and the second connecting interface 80 will form the data exchange path between the wireless earphone device 60 and the audio system 10 together, thereby the MP3 module 21 may generate an enable signal in response to the indication of an incoming call of the mobile phone 3 after the wireless communication between the wireless earphone device 60 and the mobile phone 3 is established. The enable signal may enable the audio host 11 to enter the speaker phone mode via the second connecting interface 80. In the speaker phone mode of the audio host 11, the MP3 module 21 will transmit the audio signal from the mobile phone 3 from the wireless earphone device 60 to the audio host 11, and the speaker 13 will broadcast the audio signal; the audio host 11 will transmit the sound signal collected by the microphone 12 to the wireless earphone device 60 via the MP3 module 21, so that the wireless earphone device 60 may transmit a signal to the mobile phone 3.

In the car audio system implemented according to the first and second embodiments of the present invention, when a call comes into the mobile phone 3, the MP3 player 20 will enable the audio system 10 to enter the speaker phone mode to decide whether to receive the incoming call or not by the operation of the MP3 player 20, so that the audio system 10 can establish a bidirectional audio communication with the mobile phone. In the second embodiment, when considering the reception of a private call, the driver may depart the wireless earphone device 60 from the MP3 player 20 to cut off the speaker phone mode of the audio system 10, and use the wireless earphone device 60 to make a conversation.

Referring to FIG. 3, a method flowchart of the car audio system according to the present invention is illustrated. The inventive method, which is implemented in the car audio system as shown in FIG. 1 or FIG. 2, allows the audio host 11 having the function of speaker phone to establish a bidirectional audio communication with the mobile phone 3. The method of the present invention comprises the following steps:

STEP 101: The MP3 Module Establishes an Electrical Connection to the Audio Host

The MP3 player 20 may connect the audio system 10 via connecting interfaces 30, 80, so that the MP3 module 21 may establish an electrical connection to the audio host 11. And the MP3 module 21 may control the wireless earphone module 22 or wireless earphone device 60 to establish a bidirectional communication with the mobile phone 3.

STEP 102: The Audio Host Operates in the Recording/Playing Mode

When the audio host 10 operates in the recording/playing mode, the driver can operate the panel of the audio host 11 to listen to music or radio programs.

STEP 103: The MP3 Module Enters the Speaker Phone Mode in Response to an Incoming Call

When the MP3 module 21 has established a wireless connection to the mobile phone 3, the MP3 module 21 will transmit an enable signal to the audio host 11 in response to the indication of an incoming call from the mobile phone 3 to enable the audio host 11 to enter the speaker phone mode. When the audio host 11 entered the speaker phone mode, the audio host 11 may receive an ringing audio signal from the MP3 module 21 and broadcast it via the speaker 13 to indicate the driver that the mobile phone 3 has an incoming call.

STEP 104: The MP3 Module Determines to Receive the Incoming Call

When the driver knows via the speaker phone mode that the mobile phone 3 has an incoming call, the driver may operate the MP3 player 20 to decide whether to receive the incoming call or not. The MP3 module 21 will receive the instruction requested by the driver by using the key input unit to determine whether to receive the incoming call or not. If the MP3 module 21 determines based on the instruction requested by the driver that the incoming call of the mobile phone will not be received, the MP3 module 21 will stop transmitting the ringing audio signal and instruct the mobile phone 3 via the wireless earphone module 22 or wireless earphone device 60 to cut off the signal of the incoming call, then the audio host 11 will interrupt the speaker phone mode and continue performing STEP 102; otherwise if the MP3 module 21 determines based on the instruction requested by the driver that the incoming call of the mobile phone will be received, then STEP 105 is performed.

STEP 105: The Audio Host Operates in the Speaker Phone Mode

When the audio host 11 operates in the speaker phone mode, the audio host 11 may establish a wireless bidirectional audio communication with the mobile phone 3 via the MP3 module 21. In the first embodiment of the present invention, the MP3 module 21 will receive the instruction requested by the driver by using the key input unit to determine whether the conversation is over or not. If the MP3 module 21 determines that the conversation is not over, then it may continue performing STEP 105; if the MP3 module 21 determines based on the instruction requested by the driver to cut off the conversation, then the audio host 11 will interrupt the speaker phone mode and continue performing STEP 102.

In the second embodiment of the present invention, the MP3 module 21 will receive the instruction requested by the driver by using the key input unit to determine whether the conversation is over or not, and the STEP 106 is performed to detect whether the wireless earphone device 60 is separated.

STEP 106: Separate the Wireless Earphone

When the driver wants to quit using the speaker phone mode of the audio system 10 to establish a conversation in order to hold his privacy, he can depart the wireless earphone device 60 from the MP3 player 20 anytime. When the MP3 module 21 determines that the wireless earphone device 60 is not departed from the MP3 player 20, then STEP 109 is performed to determine whether the conversation is over; otherwise if the MP3 module 21 determines that the wireless earphone device 60 is departed from the MP3 player 20, then STEP 107 is performed.

STEP 107: Interrupt the Speaker Phone Mode of the Audio Host

When the MP3 module 21 determines that the wireless earphone device 60 is departed from the MP3 player 20, the audio host 11 may interrupt the speaker phone mode based on the determination of the MP3 module 21.

STEP 108: Use the Wireless Earphone

When the wireless earphone device 60 is departed from the MP3 player 20, the wireless earphone device 60 still keeps the bidirectional audio communication with the mobile phone. Thus, the driver can use the wireless earphone device 60 to establish a conversation to avoid the conversation contents being heard by outsiders, thereby holding his privacy.

STEP 109: Conversation is Over

If the MP3 module determines that the conversation is not over, then it will continue performing STEP 105; otherwise if the MP3 module 21 determines based on the instruction requested by the driver to cut off the conversation, then the audio host 11 will interrupt the speaker phone mode and continue performing STEP 102.

Referring to FIG. 4, a recording flowchart of the car audio system according to the present invention is illustrated. The inventive method, which is implemented in the car audio system as shown in FIG. 1 or FIG. 2, allows the MP3 player 20 to establish a bidirectional audio communication between the audio host 11 having the function of speaker phone and the mobile phone 3 as well as generate a recording file. The method of the present invention comprises the following steps:

STEP 201: The MP3 Module Establishes an Electrical Connection to the Audio Host

The MP3 player 20 may connect the audio system 10 via connecting interfaces 30, 80, so that the MP3 module 21 may establish an electrical connection to the audio host 11. And the MP3 module 21 may control the wireless earphone module 22 or wireless earphone device 60 to establish a bidirectional communication with the mobile phone 3.

STEP 202: The Audio Host Module Operates in the Speaker Phone Mode

When the MP3 module 21 has established a wireless connection to the mobile phone 3, the MP3 module 21 will transmit an enable signal to the audio host 11 in response to the indication of an incoming call from the mobile phone 3 to enable the audio host 11 to enter the speaker phone mode.

STEP 203: The MP3 Module Determines the Recording Operation

When the driver makes a conversation via the speaker phone mode, he can operate the MP3 player 20 to perform the recording operation. The MP3 module 21 may receive the instruction requested by the driver by using the key input unit to determine whether to perform the recording operation. If the MP3 module 21 determines based on the instruction requested by the driver that the recording operation is needed, then the STEP 204 is performed; otherwise continuing performing STEP 202.

STEP 204: The MP3 Module Generates and Stores a Recording File for the Conversation

The MP3 module 21 is provided between the audio system 10 and the wireless earphone module 22 or the wireless earphone device 60, therefore the MP3 module 21 can record the conversation made by the driver via the speaker phone mode, and the MP3 module 21 can generate a recording file and stores the recording file in a memory unit.

Having described the preferred embodiments of the present invention in detail, those skilled in the art will clearly understand that various variations and changes can be made without departing from the scope and spirit of the following claims, and the present invention is not limited to the implementations of these embodiments of the specification.

1. A car audio system, comprising:
an audio system, comprising an audio host, a microphone, and a speaker, wherein said audio host has a speaker phone mode;
a MP3 player, comprising a MP3 module and a wireless earphone module, wherein said MP3 module may establish a bidirectional communication with a mobile phone via said wireless earphone module; and
a connecting interface for connecting the electrical connection between said MP3 module and said audio host,
wherein, said MP3 module may enable the audio host to enter the speaker phone mode in response to the indication of an incoming call of the mobile phone, thereby making said audio system establish a bidirectional audio communication with said mobile phone via said MP3 player.

2. The car audio system of claim 1, wherein said audio host is operated in said speaker phone mode, and said audio host may receive the audio signal transmitted from said MP3 module and broadcast it via said speaker, and said audio host may receive the sound signal or driver's voice via said microphone and transmit it to said MP3 module.

3. The car audio system of claim 1, wherein said audio system further comprises an interface circuit, said interface circuit may receive the signal from said MP3 player via said connecting interface and transmit it to said audio host, and said interface circuit may also simultaneously transmit the signal from said audio host to said MP3 player via said connecting interface.

4. The car audio system of claim 1, wherein said MP3 player further comprises an interface circuit, said interface circuit may receive the signal from said audio system via said connecting interface and transmit it to said MP3 module, and said interface circuit may also simultaneously transmit the signal from said MP3 module to said audio system via said connecting interface.

5. The car audio system of claim 1, wherein said connecting interface comprises electrical connecting points or electrical connectors provided on the panel of said audio system, and electrical connecting points or electrical connectors provided on said MP3 player.

6. The car audio system of claim 1, wherein said MP3 module may control said wireless earphone module to cut off the incoming call of the mobile phone.

7. The car audio system of claim 1, wherein said MP3 module may transmit an enable signal to said audio host in response to the indication of an incoming call of the mobile phone, thereby enabling the audio host to enter the speaker phone mode.

8. A car audio system, comprising:
an audio system, comprising an audio host, a microphone, and a speaker, wherein said audio host has a speaker phone mode;
a MP3 player, comprising a MP3 module;
a wireless earphone device, wherein said wireless earphone device may establish a wireless connection with a mobile phone; and
wherein, a first connecting interface may connect the electrical connection between said MP3 player and said wireless earphone device, a second connecting interface may connect the electrical connection between said MP3 module and said audio host, and said MP3 module may transmit the indication of an incoming call of the mobile phone in response to said wireless earphone device so that said MP3 module may send an enable signal to said audio host, thereby enabling the audio host to enter the speaker phone mode.

9. The car audio system of claim 8, wherein said audio host is operated in said speaker phone mode, and said audio host may receive the audio signal transmitted from said MP3 module and broadcast it via said speaker, and said audio host may receive the sound signal or driver's voice via said microphone and transmit it to said MP3 module.

10. The car audio system of claim 8, wherein said audio system further comprises an interface circuit, said interface circuit may receive the signal from said MP3 player via said second connecting interface and transmit it to said audio host, and said interface circuit may also simultaneously transmit the signal from said audio host to said MP3 player via said second connecting interface.

11. The car audio system of claim 8, wherein said MP3 player further comprises an interface circuit, said interface circuit may receive the signal from said audio system via said second connecting interface and transmit it to said MP3 module, and said interface circuit may also simultaneously transmit the signal from said MP3 module to said audio system via said second connecting interface.

12. The car audio system of claim 8, wherein said second connecting interface comprises electrical connecting points or electrical connectors provided on the panel of said audio system, and electrical connecting points or electrical connectors provided on said MP3 player.

13. The car audio system of claim 8, wherein said first connecting interface comprises electrical connecting points or electrical connectors provided on said wireless earphone device, and electrical connecting points or electrical connectors provided on said MP3 player.

14. A method for establishing a bidirectional audio communication between a car audio host and a mobile phone, said car audio host has the function of speaker phone, wherein the method comprises the following steps:
providing a MP3 player which has a speaker phone mode, said MP3 player may control said wireless earphone module to establish a bidirectional communication with a mobile phone;
providing a connecting interface so that there is an electrical connection between said MP3 player and said car audio host; and
said MP3 player may instruct said car audio host to enter the speaker phone mode in response to the indication of an incoming call of the mobile phone.

15. The method of claim 14 for establishing a bidirectional audio communication between a car audio host and a mobile phone, further comprising the following step: said MP3 player may generate an enable signal in response to the indication of an incoming call of the mobile phone.

16. The method of claim 14 for establishing a bidirectional audio communication between a car audio host and a mobile phone, further comprising the following step: said MP3 player may transmit said enable signal to said car audio host vai said connecting interface, thus enabling said car audio host to enter the speaker phone mode.

17. The method of claim 14 for establishing a bidirectional audio communication between a car audio host and a mobile phone, further comprising the following step: after said car audio host entering the speaker phone mode, said MP3 player may transmit the audio signal from the mobile phone to said car audio host via said connecting interface.

18. The method of claim 14 for establishing a bidirectional audio communication between a car audio host and a mobile phone, further comprising the following step: after said audio host entering the speaker phone mode, said car audio host may transmit driver's audio signal to said MP3 player via said connecting interface, and then said MP3 player may transmit driver's audio signal to the mobile phone.

19. The method of claim 14 for establishing a bidirectional audio communication between a car audio host and a mobile phone, further comprising the following step: after said car audio host entering the speaker phone mode, said MP3 player may execute the recording task.

20. A method for establishing a bidirectional audio communication between a car audio host and a mobile phone, said car audio host has the function of speaker phone, wherein the method comprises the following steps:
providing a first connecting interface so that there is an electrical connection between a MP3 player and a wireless earphone device, said MP3 player may control said wireless earphone device to establish a bidirectional communication with a mobile phone;
providing a second connecting interface so that there is an electrical connection between said MP3 player and said car audio host; and
said MP3 player may instruct said car audio host to enter the speaker phone mode in response to the indication of an incoming call of the mobile phone.

21. The method of claim 20 for establishing a bidirectional audio communication between a car audio host and a mobile phone, further comprising the following step: said MP3 player may generate an enable signal in response to the indication of an incoming call of the mobile phone.

22. The method of claim 20 for establishing a bidirectional audio communication between a car audio host and a mobile phone, further comprising the following step: said MP3 player may transmit said enable signal to said audio host via said connecting interface, thus enabling said car audio host to enter the speaker phone mode.

23. The method of claim 20 for establishing a bidirectional audio communication between a car audio host and a mobile phone, further comprising the following step: after said car audio host entering the speaker phone mode, said MP3 player may transmit the audio signal from the mobile phone to said car audio host via said connecting interface.

24. The method of claim 20 for establishing a bidirectional audio communication between a car audio host and a mobile phone, further comprising the following step: after said car audio host entering the speaker phone mode, said car audio host may transmit driver's audio signal to said MP3 player via said connecting interface, and then said MP3 player may transmit driver's audio signal to the mobile phone.

25. The method of claim 20 for establishing a bidirectional audio communication between a car audio host and a mobile phone, further comprising the following step: after said car audio host entering the speaker phone mode, said MP3 player may execute the recording task.
